(19) United States
(12) Patent Application Publication
(10) Pub. No.: US 2022/0403800 A1
(43) Pub. Date: Dec. 22, 2022

(54) HYDROGEN EJECTOR FOR ROCKET ENGINE

(71) Applicant: Motoki MIMORI, Nakama-shi, Fukuoka (JP)

(72) Inventor: Motoki MIMORI, Nakama-shi, Fukuoka (JP)

(21) Appl. No.: 17/429,626

(22) PCT Filed: Jun. 17, 2021
(86) PCT No.: PCT/JP2021/023011

§ 371 Date: Aug. 10, 2021

(51) Int. Cl. F02K 9/60; F02K 9/97

(52) U.S. Cl. CPC F02K 9/60; F02K 9/97

(57) ABSTRACT

To provide an ejector for a rocket engine in which an engine nozzle body having a simpler structure can be used. A hydrogen ejector 10 for a rocket engine comprises an engine nozzle body 12 for ejecting hydrogen gas and an ejection unit 14 for ejecting hydrogen gas while controlling the temperature of the hydrogen gas within a temperature range in which a material constituting the engine nozzle body 12 through which the hydrogen gas flows can maintain its strength. The temperature range is 500° C. to 1000° C. The hydrogen gas comprises hydrogen gas generated by incomplete combustion during a combustion reaction between liquid hydrogen and liquid oxygen.

### TECHNICAL FIELD

The present invention relates to a hydrogen ejector for a rocket engine.

### BACKGROUND ART

Rocket engines configured to obtain thrust in reaction to ejection of a propellant have been developed so far. One example of techniques related to the present invention is a liquid propellant supply system for a rocket engine disclosed in Patent Document 1. In the liquid propellant supply system for a rocket engine, the liquid propellant is a cryogenic liquid propellant, and a means for supplying the cryogenic liquid propellant to a combustion chamber of a rocket engine is a motor pump of a canned motor pump type in which a pump unit and a motor unit are formed as one body with the motor unit being sealed in a can.

### PRIOR ART DOCUMENT

### Patent Documents

Patent Document 1: JP-A 2021-67180

### SUMMARY OF INVENTION

### Technical Problem

The combustion temperature in rocket engines reaches up to 3000° C. or higher, although depending on fuel, combustion pressure, and the like. For this reason, the engine nozzle body is made of a heat-resistant alloy in order to keep the engine nozzle body from melting. However, even such a heat-resistant alloy easily melts at 3000° C. without any protection. To avoid this, liquid hydrogen fuel (−253° C.) is allowed to flow within tubes which form a wall surface of a nozzle skirt to cool the engine nozzle body. Thus, the engine nozzle body has a complicated configuration in which, for example, hydrogen used to cool the rocket engine is collected as a fuel.

The purpose of the present invention is to provide an ejector for a rocket engine in which an engine nozzle body having a simpler structure can be used.

### Solution to Problem

A hydrogen ejector for a rocket engine according to the present invention comprises: an engine nozzle body for ejecting hydrogen gas; and an ejection unit for ejecting the hydrogen gas while controlling the temperature of the hydrogen gas within a temperature range in which a material constituting the engine nozzle body through which the hydrogen gas flows can maintain its strength.

In the hydrogen ejector for a rocket engine according to the present invention, the temperature range is preferably 500° C. to 1000° C.

In the hydrogen ejector for a rocket engine according to the present invention, the hydrogen gas preferably consists only of hydrogen.

In the hydrogen ejector for a rocket engine according to the present invention, the hydrogen gas preferably comprises hydrogen gas generated as a result of incomplete combustion during a combustion reaction between liquid hydrogen and liquid oxygen.

A hydrogen ejection method for a rocket engine according to the present invention comprises the steps of:

controlling the temperature of hydrogen gas to be introduced into an engine nozzle body within a temperature range in which a material constituting the engine nozzle body can maintain its strength, the engine nozzle body being configured to obtain thrust in reaction to ejection of the hydrogen gas; and

ejecting the hydrogen gas controlled within the temperature range.

In the hydrogen ejection method for a rocket engine according to the present invention, the temperature range is preferably 500° C. to 1000° C.

In the hydrogen ejection method for a rocket engine according to the present invention, the hydrogen gas preferably consists only of hydrogen.

In the hydrogen ejector for a rocket engine according to the present invention, the hydrogen gas preferably comprises hydrogen gas generated as a result of incomplete combustion during a combustion reaction between liquid hydrogen and liquid oxygen.

### Advantageous Effects of Invention

The present invention makes it possible to use an engine nozzle body having a simpler structure.

### BRIEF DESCRIPTION OF THE DRAWINGS

FIG. 1 shows a configuration diagram of an ejector for a rocket engine according to an embodiment of the present invention.

FIG. 2 shows the results of a simulation of the flow velocity during ejection from the ejector for a rocket engine according to an embodiment of the present invention.

FIG. 3 shows the results of a simulation of temperature changes during ejection from the ejector for a rocket engine according to an embodiment of the present invention.

FIG. 4 shows the results of a simulation of the pressure distribution during ejection from the ejector for a rocket engine according to an embodiment of the present invention.

FIG. 5 shows the results of a simulation of ejecting hydrogen from the ejector for a rocket engine according to an embodiment of the present invention.

FIG. 6 shows the results of a simulation of ejecting helium from the ejector for a rocket engine according to an embodiment of the present invention.

FIG. 7 shows the results of a simulation of ejecting vapor (overheated) from the ejector for a rocket engine according to an embodiment of the present invention.

FIG. 8 shows the results of a simulation of ejecting nitrogen from the ejector for a rocket engine according to an embodiment of the present invention.

### DESCRIPTION OF EMBODIMENTS

The following illustrates an embodiment of the present invention in detail with reference to the attached drawings. In all the figures of the drawings, the same elements are assigned the same reference numerals to omit redundant explanation. In the description below, the same reference numerals as previously denoted are used as necessary.

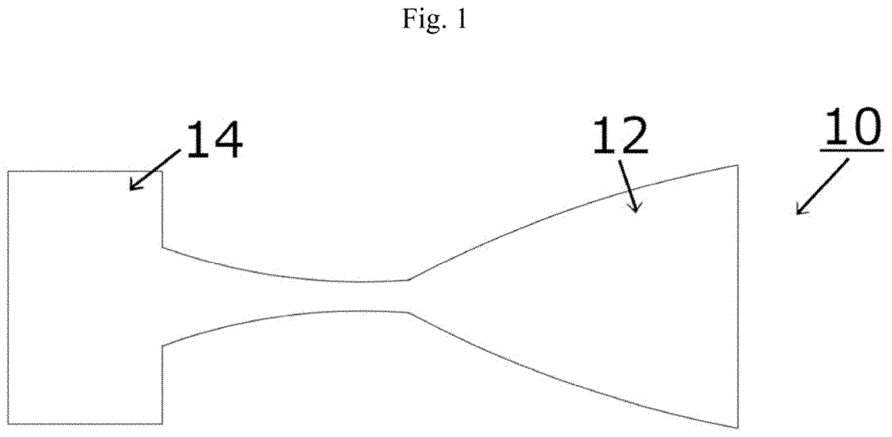

FIG. 1 shows a configuration diagram of an ejector 10 for a rocket engine according to an embodiment of the present invention. The ejector 10 for a rocket engine is provided with an engine nozzle body 12 and an ejection unit 14. The engine nozzle body 12 is a nozzle for ejecting hydrogen gas. The engine nozzle body 12 has a substantially bell-like shape and is formed of an aluminum alloy such as duralumin.

The ejection unit 14 is a combustion unit for ejecting hydrogen gas while controlling the temperature of the hydrogen gas within a temperature range in which the material constituting the engine nozzle body 12 through which the hydrogen gas flows can maintain its strength. The ejection unit 14 is formed of a material having adequate strength such as an aluminum alloy (e.g., duralumin), and communicates with the engine nozzle body 12.

The temperature range in which the material constituting the engine nozzle body 12 can maintain its strength is 500° C. to 1000° C. The hydrogen gas comprises hydrogen generated as a result of incomplete combustion during a combustion reaction between liquid hydrogen and liquid oxygen.

A larger amount of hydrogen is mixed with oxygen. Because of the low temperature of hydrogen, incomplete combustion occurs, and hydrogen gas is ejected with impurities such as vapor. Specifically, in the combustion reaction between liquid hydrogen and liquid oxygen, excess hydrogen is added so that the amount of hydrogen within the ejection unit 14 is larger than a reference amount necessary for complete combustion by an amount which reduces the temperature in the combustion chamber to a target temperature (500° C. to 1000° C.)

Incomplete combustion can be represented by the formula kH₂+O₂→(k−2)H₂+2H₂O+Q (wherein k is a number of 2 or greater (may be a non-integer) and Q is the amount of heat released by combustion). Q can be considered as the amount of heat which warms hydrogen and water vapor.

Accordingly, the reaction is caused while the K value is set to control the temperature of (k−2)H₂+2H₂O to a temperature of 500° C. to 1000° C., which can be defined as “low temperature of hydrogen”. The k value indicates how excess hydrogen is used.

The following description illustrates how the ejector 10 for a rocket engine having the above-described configuration works. First, hydrogen gas controlled within the temperature range of 500° C. to 1000° C. is generated in the ejection unit 14 by incomplete combustion during a combustion reaction between liquid hydrogen and liquid oxygen (S2). In the temperature range of hydrogen gas of 500° C. to 1000° C., the material constituting the engine nozzle body 12 which obtains thrust in reaction to ejection of the hydrogen gas can maintain its strength.

Thus, the hydrogen gas controlled to 500° C. to 1000° C. is ejected from the engine nozzle body 12 (S4). Using the thrust generated in reaction to ejection, a rocket can fly.

Here, the results of a simulation of ejecting hydrogen controlled to a temperature of about 500° C. to about 1000° C. in the ejection unit 14 from the engine nozzle body 12 are shown. The simulation results shown here are obtained by verification using CFD simulation software.

CFD is an abbreviation of computational fluid dynamics, and is a numerical analysis/simulation tool for visualizing fluid flow by solving equations relating to fluid motion (Euler equations, Navier-Stokes equations, or equations derived therefrom) using a computer by numerical analysis of partial differential equations, for example.

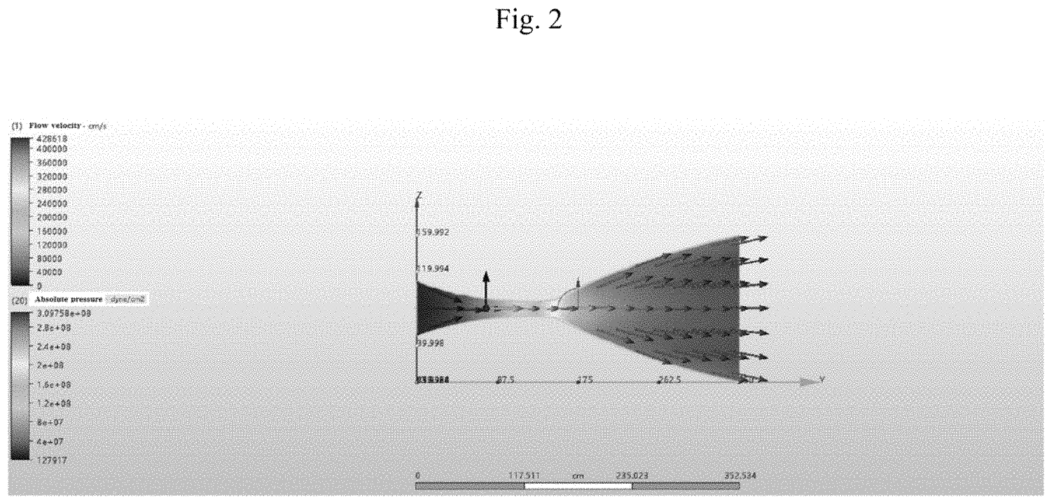

FIG. 2 shows the results of a simulation of the flow velocity during ejection from the ejector 10 for a rocket engine. In this case, the speed reached 4100 m/s, suggesting that the temperature in the combustion chamber, which is equal to the temperature of the fluid, was decreased to 500° C.

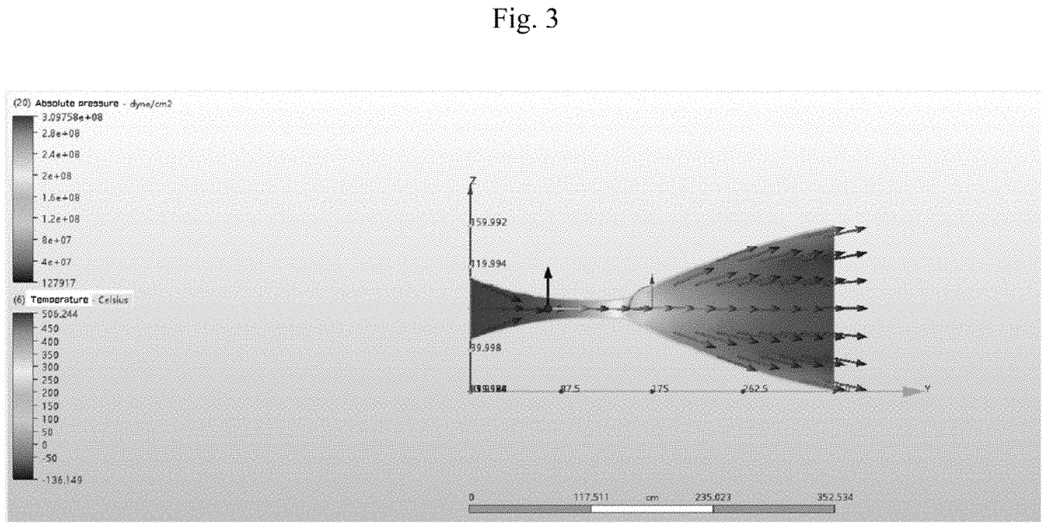

FIG. 3 shows the results of a simulation of the temperature during ejection from the ejector 10 for a rocket engine. As shown in FIG. 3, ejection of a fluid having a reduced temperature of 500° C. reduced the temperature of the fluid (hydrogen) at the discharge outlet of the nozzle to −86° C.

As a result of reducing the temperature of the fluid (hydrogen) at the discharge outlet of the nozzle to −86° C., it is no longer necessary to make an effort to prevent the discharge outlet of the nozzle from melting. Aluminum alloys such as duralumin are sufficiently adequate.

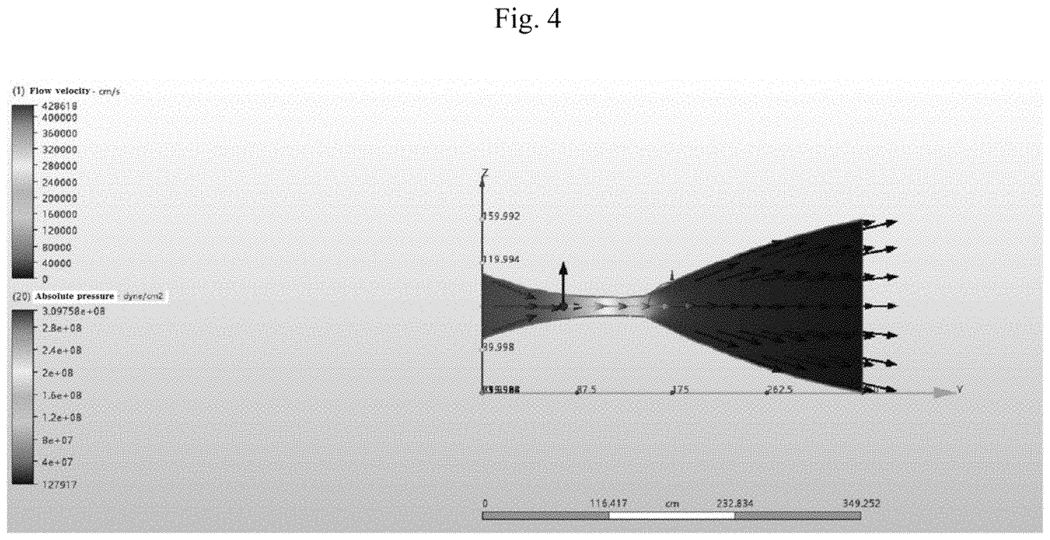

FIG. 4 shows the results of a simulation of the pressure distribution during ejection from the ejector 10 for a rocket engine. The pressure in the ejection unit 14, which serves as a combustion chamber, and the pressure at the fluid inlet of the engine nozzle body 12 were about 300 atm absolute. The lower left value in FIG. 4 is the pressure in the vicinity of the fluid inlet. This value is deemed to be practical in consideration of the fact that the pressure of a bottle for storing compressed hydrogen gas is 700 atm.

For purposes of comparison, the results of four simulations using hydrogen, helium, vapor (overheated), and nitrogen are examined.

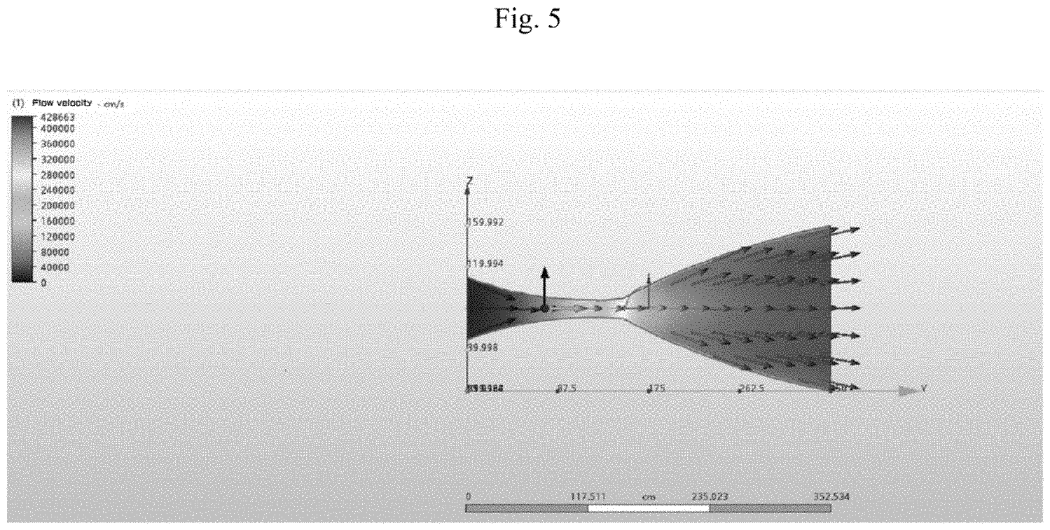

FIG. 5 shows the results of a simulation of ejecting hydrogen from the ejector 10 for a rocket engine. As shown in FIG. 5, the ejection of hydrogen resulted in a density (at normal temperature and normal pressure) of 0.0000838349 (g/cm³) and a maximum speed at the discharge outlet of about 4100 m/s.

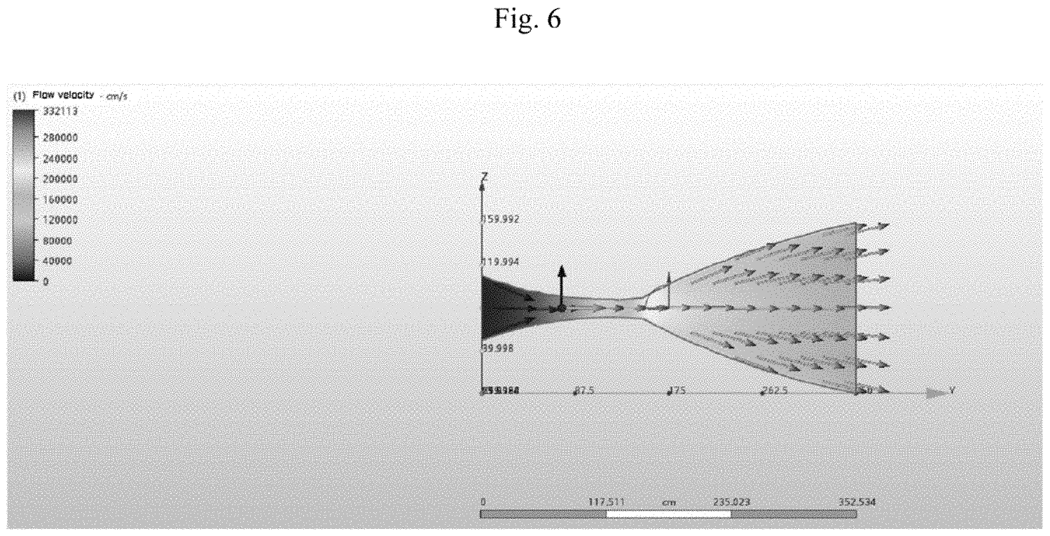

FIG. 6 shows the results of a simulation of ejecting helium from the ejector 10 for a rocket engine. As shown in FIG. 6, the ejection of helium resulted in a density (at normal temperature and normal pressure) of 0.000166339 (g/cm³) and a maximum speed at the discharge outlet of about 2600 m/s.

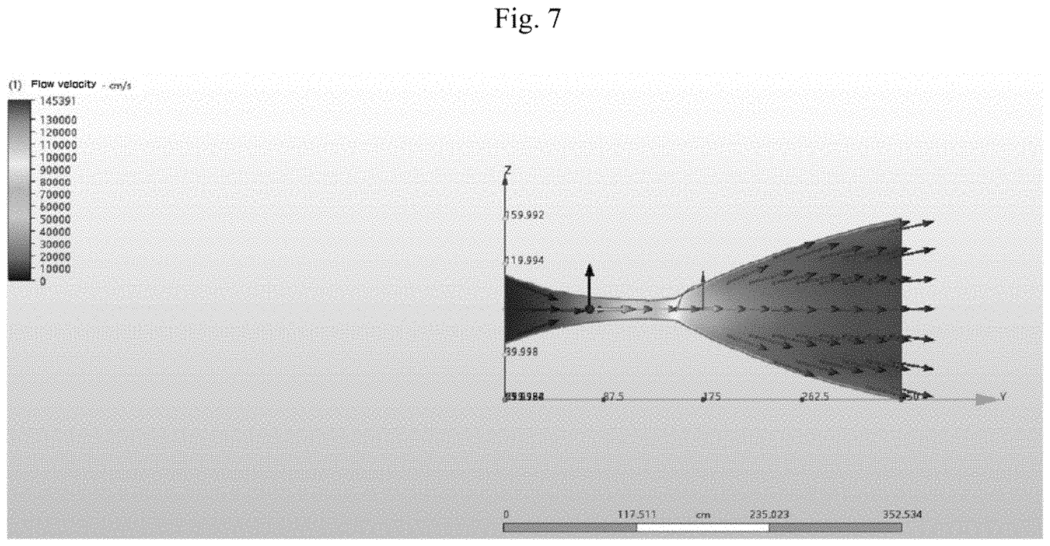

FIG. 7 shows the results of a simulation of ejecting vapor (overheated) from the ejector 10 for a rocket engine. As shown in FIG. 7, the ejection of vapor (overheated) resulted in a density (at normal temperature and normal pressure) of 0.000758558 (g/cm³) and a maximum speed at the discharge outlet of about 1400 m/s.

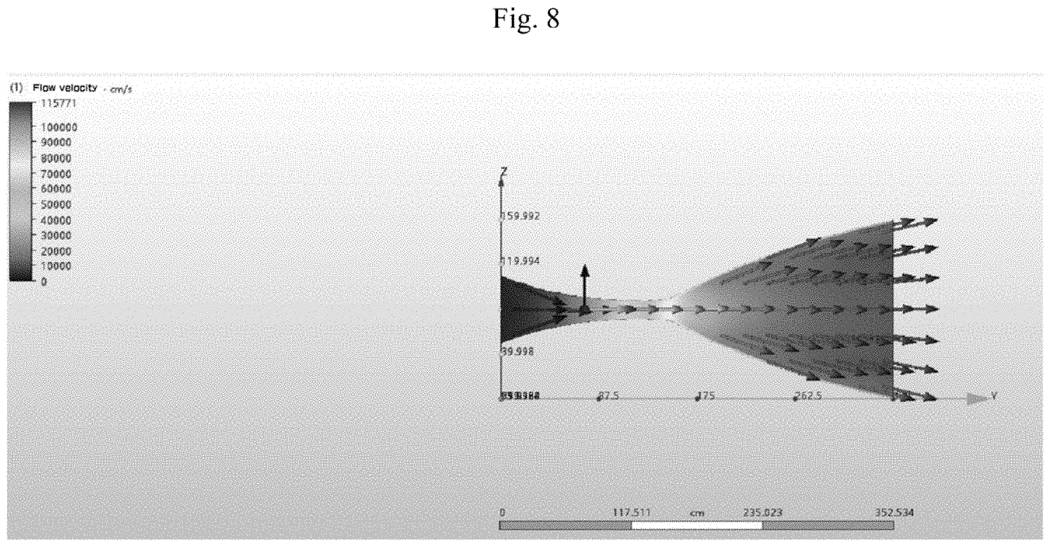

FIG. 8 shows the results of a simulation of ejecting nitrogen from the ejector 10 for a rocket engine. As shown in FIG. 8, the ejection of vapor nitrogen resulted in a density (at normal temperature and normal pressure) of 0.00116516 (g/cm³) and a maximum speed at the discharge outlet of about 1400 m/s.

A comparison of FIGS. 5 to 8 highlights the impressive speed achieved by ejecting hydrogen shown in FIG. 5. The gas weight increases in the order of hydrogen, helium, vapor (overheated), and nitrogen. There is a trend that a greater density corresponds to a lower ejection speed.

Namely, the ejection speed is obtained by acceleration caused by the same phenomenon as adiabatic expansion which occurs when compressed gas is released, and by a reduction in temperature by kinetic energy required therefor. Accordingly, a smaller density corresponds to greater acceleration by adiabatic expansion, and corresponds to acceleration to a higher speed.

Additionally, control of the gas temperature to 500° C. to 1000° C. makes it possible to use materials such as iron and titanium without cooling, and provides a significant advantage that a tremendously safe engine structure can be used. Another advantage is that by ejecting hydrogen at a low temperature (about 500° C.), a higher ejection speed can be achieved compared to other materials.

Although in the above description, the ejector 10 for a rocket engine ejects hydrogen gas controlled within the temperature range of 500° C. to 1000° C. by incomplete combustion during a combustion reaction between liquid hydrogen and liquid oxygen, other techniques can be used to eject hydrogen gas controlled within the temperature range of 500° C. to 1000° C.

As an example of techniques to eject pure hydrogen gas alone without the combustion reaction, liquid hydrogen for ejection may be heated and vaporized into hydrogen gas and only the hydrogen gas may be ejected.

### REFERENCE SIGNS LIST

10 Ejector for rocket engine
12 Engine nozzle body
14 Ejection unit

1. A hydrogen ejector for a rocket engine, the hydrogen ejector comprising:
an engine nozzle body for ejecting hydrogen gas; and
an ejection unit for ejecting the hydrogen gas while controlling the temperature of the hydrogen gas within a temperature range in which a material constituting the engine nozzle body through which the hydrogen gas flows can maintain its strength.

2. The hydrogen ejector for a rocket engine according to claim 1,
wherein the temperature range is 500° C. to 1000° C.

3. The hydrogen ejector for a rocket engine according to claim 1,
wherein the hydrogen gas consists only of hydrogen.

4. The hydrogen ejector for a rocket engine according to claim 1,
wherein the hydrogen gas comprises hydrogen gas generated as a result of incomplete combustion during a combustion reaction between liquid hydrogen and liquid oxygen.

5. A hydrogen ejection method for a rocket engine, the method comprising the steps of:
controlling the temperature of hydrogen gas to be introduced into an engine nozzle body within a temperature range in which a material constituting the engine nozzle body can maintain its strength, the engine nozzle body being configured to obtain thrust in reaction to ejection of the hydrogen gas; and
ejecting the hydrogen gas controlled within the temperature range.

6. The hydrogen ejection method for a rocket engine according to claim 5,
wherein the temperature range is 500° C. to 1000° C.

7. The hydrogen ejection method for a rocket engine according to claim 5,
wherein the hydrogen gas consists only of hydrogen.

8. The hydrogen ejection method for a rocket engine according to claim 5,
wherein the hydrogen gas comprises hydrogen gas generated as a result of incomplete combustion during a combustion reaction between liquid hydrogen and liquid oxygen.
